(19) United States
(12) Patent Application Publication
(10) Pub. No.: US 2022/0114055 A1
(43) Pub. Date: Apr. 14, 2022

(54) TRANSPARENT DYNAMIC REASSEMBLY OF COMPUTING RESOURCE COMPOSITIONS

(71) Applicants: Kshitij Arun Doshi, Tempe, AZ (US); Francesc Guim Bernat, Barcelona (ES); Christian Maciocco, Portland, OR (US); Ned M. Smith, Beaverton, OR (US); S M Iftekharul Alam, Hillsboro, OR (US); Satish Chandra Jha, Portland, OR (US); Vesh Raj Sharma Banjade, Portland, OR (US); Alexander Bachmutsky, Sunnyvale, CA (US)

(72) Inventors: Kshitij Arun Doshi, Tempe, AZ (US); Francesc Guim Bernat, Barcelona (ES); Christian Maciocco, Portland, OR (US); Ned M. Smith, Beaverton, OR (US); S M Iftekharul Alam, Hillsboro, OR (US); Satish Chandra Jha, Portland, OR (US); Vesh Raj Sharma Banjade, Portland, OR (US); Alexander Bachmutsky, Sunnyvale, CA (US)

(21) Appl. No.: 17/559,877

(22) Filed: Dec. 22, 2021

(51) Int. Cl. G06F 11/14; G06F 9/50; G06F 9/455

(52) U.S. Cl. CPC G06F 11/1428; G06F 11/1492; G06F 11/1469; G06F 2209/5011; G06F 9/5077; G06F 9/45558; G06F 2009/45579; G06F 11/1456

(57) ABSTRACT

Systems and techniques for transparent dynamic reassembly of computing resource compositions are described herein. An indication may be obtained of an error state of a component of a computing system. An offload command may be transmitted to component management software of the computing system. An indication may be received that workloads to be executed using the component have been suspended. An administrative mode command may be transmitted to the component. The administrative mode command may place the component in partial shutdown to prevent the component from receiving non-administrative workloads. Data of the component may be synchronized with a backup component. Workloads from the component may be transferred to the backup component. An offload release command may be transmitted to the software of the computing system.

### TECHNICAL FIELD

Embodiments described herein generally relate to computing resource resiliency and, in some embodiments, more specifically to transparent dynamic reassembly of computing resource compositions.

### BACKGROUND

Computing systems include a number of components that are subject to failure (e.g., complete failure, performance degradation, etc.). Modern computing systems include a variety of either physically similar or functionally similar components, or dynamically creatable components through hardware or software virtualization methods, that may be capable of performing the functions of failed components. However, transitioning from a failed component to a functioning component may result in downtime as software and other system elements may be halted during the transition. It may be desired to transition from a failed component to a functioning component while limiting system downtime to an inconsequentially small duration.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an overview of an edge cloud configuration for edge computing.

FIG. 2 illustrates operational layers among endpoints, an edge cloud, and cloud computing environments.

FIG. 3 illustrates an example approach for networking and services in an edge computing system.

FIG. 4 illustrates deployment of a virtual edge configuration in an edge computing system operated among multiple edge nodes and multiple tenants.

FIG. 5 illustrates various compute arrangements deploying containers in an edge computing system.

FIG. 6 illustrates a compute and communication use case involving mobile access to applications in an edge computing system.

FIG. 7A provides an overview of example components for compute deployed at a compute node in an edge computing system.

FIG. 7B provides a further overview of example components within a computing device in an edge computing system.

FIG. 7C illustrates an example software distribution platform to distribute software to one or more devices.

FIG. 8 is a block diagram of an example of a system for transparent dynamic reassembly of computing resource compositions, according to an embodiment.

FIG. 9 illustrates a data flow diagram of an example of an error indicator flow for transparent dynamic reassembly of computing resource compositions, according to an embodiment.

FIG. 10 illustrates a flow chart for an example of a process for a cluster in a box manager for transparent dynamic reassembly of computing resource compositions, according to an embodiment.

FIGS. 11A and 11B illustrate an example of a transformation of a computing resource composition for transparent dynamic reassembly of computing resource compositions, according to an embodiment.

FIG. 12 illustrates a flow chart of an example of a process for device virtualization through agency of operating system/virtual machine manager software by a cluster in a box manager for transparent dynamic reassembly of computing resource compositions, according to an embodiment.

FIG. 13 is a flow chart of an example of a method for transparent dynamic reassembly of computing resource compositions, according to an embodiment.

### DETAILED DESCRIPTION

A modern networked computing node (e.g., server) comprises a multiplicity of alike physical units—central processing units (CPUs), cache slices, dual in-line memory modules (DIMMs), storage volumes, network interface controllers (NICs), graphics processing unit (GPU) tiles, etc. Within each physical unit, there may be identical subcomponents that are independently assignable and which may take over a role of another subcomponent if needed. For example, within a modern foundational NIC, there are multiple physical functions (PFs) and multiple virtual functions (VFs) within a PF. It is possible for a failing component (e.g., evidenced by higher rates of errors) to be identified and for its role to be remapped to another, comparatively more robust, component. For example, an enhanced machine check architecture for recovery feature may be used by platform software to migrate pages out of a failing DIMM and reassign them to physical pages from other memory DIMMs. Generally, these techniques are either not sufficiently software transparent, or they solve one facet of a multifaceted problem. A resiliency-oriented/resiliency-first architecture is provided that enables agile re-compositions and makes it easy to deliver them as non-intrusively and rapidly to software as possible.

Software defined infrastructure unites varying numbers of physical and virtual components in each server (e.g., a network node, etc.) and varying numbers of inter-networked servers into unitary infrastructures under software and orchestration guidance. For resilient communication, software defined networking introduces mutable channels that dynamically route around problematic or failed subnets or systems.

Existing solutions are imperfect and do not scale well. Solutions employed by cloud service providers/communication service providers (CSPs) comprise availability zones, extensive continuous integration/continuous delivery (CI/CD) methodologies, site reliability engineering divisions, and multiple layers of defense. With decentralization and with rise of edge computing, the agility with which working assemblies of computational devices are reconstituted locally is a consideration for responding to network partitions and distributed security incidents. Network partitions and distributed security incidents are complementary because higher levels of resilience at a unit and a subunit level in a distributed system naturally increases the resilience, flexibility, and recovery at the cluster and inter-datacenter level.

The systems and techniques discussed herein enable designed replaceability so that alike components may absorb roles of each other and enable programmable (e.g., reconfigurable, etc.) communication meshes which interconnect the components to permit remapping. A hardware-based self-abstraction mechanism in the server, a microvisor, carries out reconfiguration actions as directed by a software agent. A software agent is fully trusted and onboarded together with a CPU of a server and other integrated devices and this software agent functions as a cluster-in-a-box (CLUB) manager. The CLUB manager acts as a policy and control point for resiliency in the platform. The CLUB manager may assign resources or virtualize them (e.g., with help from the microvisor) with an authority that supersedes that of a virtual machine manager (VMM) or a host operating system (OS). The CLUB manager is a composer of the server that is seen by a VMM or a host OS. These techniques enable the server to self-morph so that it may substitute unstable components (e.g., failing, degraded, malfunctioning, etc.) with stable components.

Integrating the ability to morph an entire composition of resources makes servers robust against failures of individual component parts. Robust servers lead to robust clusters, cliques, and other distributed arrangements of servers. A resiliency-balancing approach is similar to load-balancing for utilization. Load-balancing removes vulnerability of performance service level agreement (SLAs) to local load spikes and resiliency-balancing removes vulnerability to local impairments.

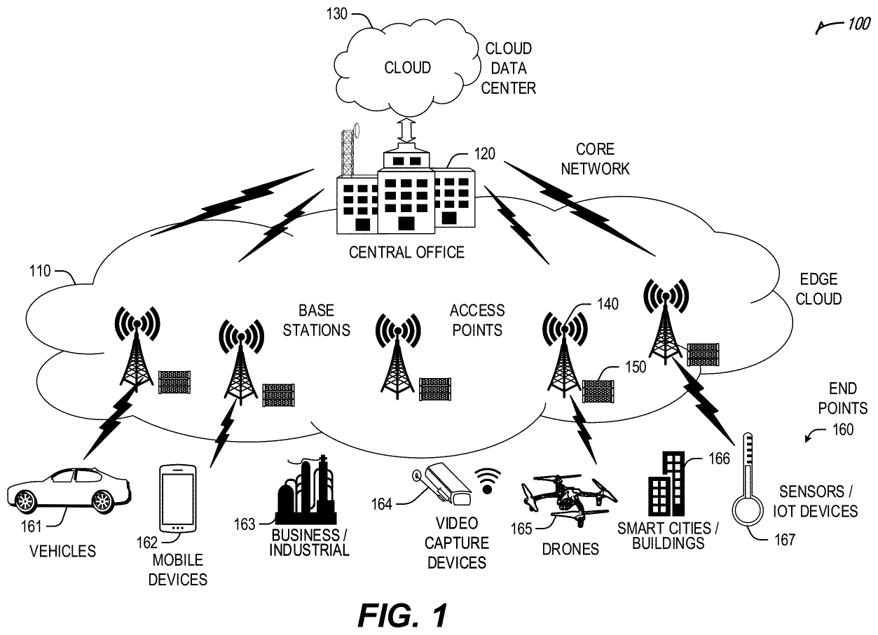

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

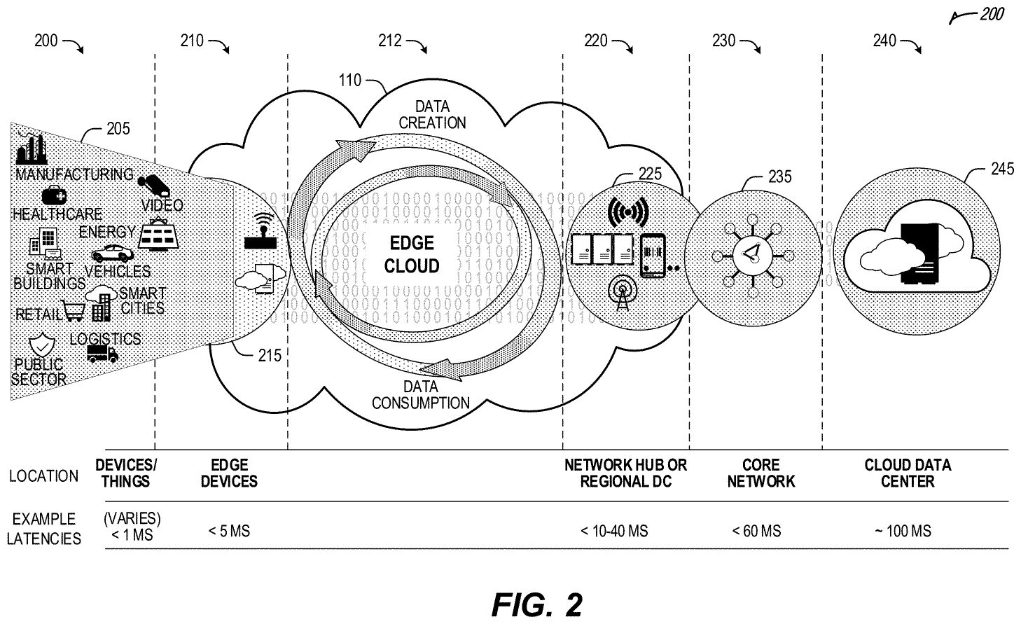

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

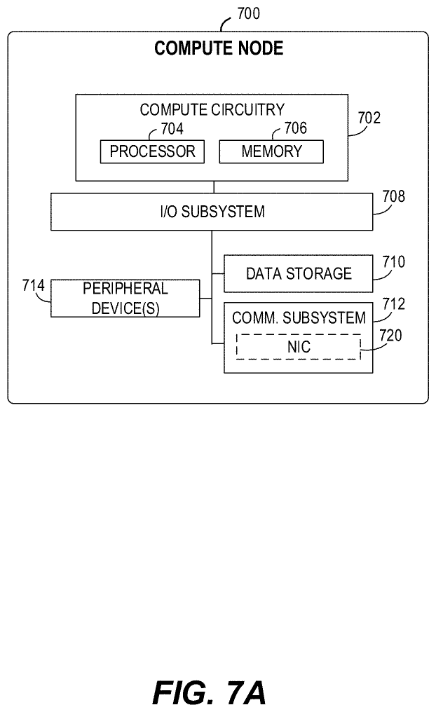

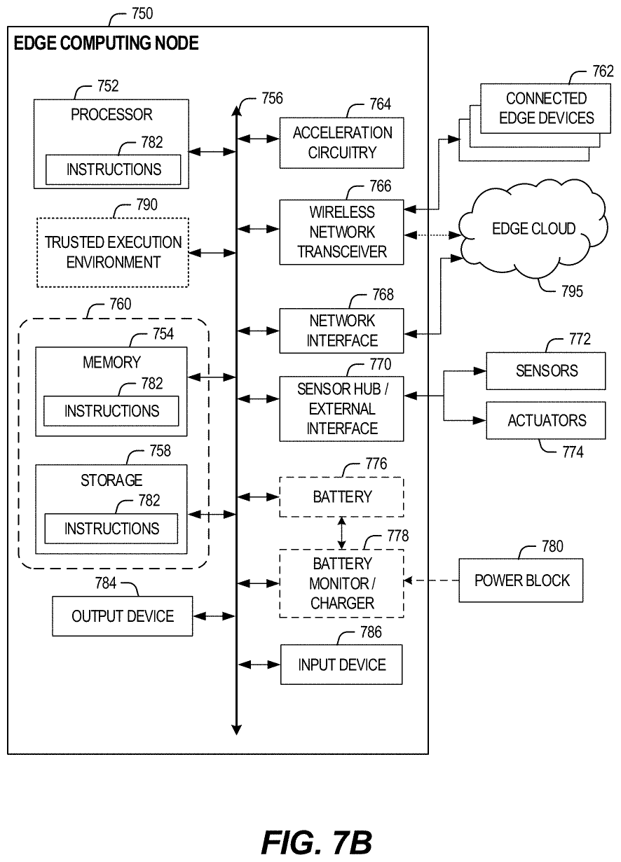

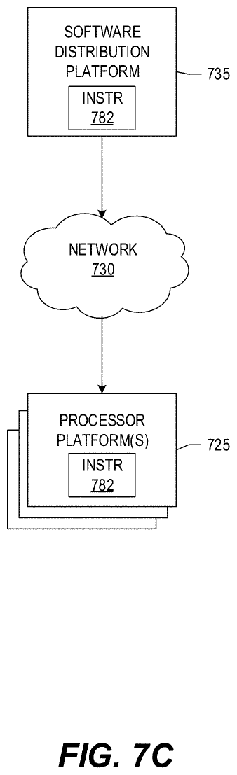

The network components of the edge cloud 110 may be servers, multi-tenant servers, appliance computing devices, and/or any other type of computing devices. For example, the edge cloud 110 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 7B. The edge cloud 110 may also include one or more servers and/or one or more multi-tenant servers. Such a server may include an operating system and a virtual computing environment. A virtual computing environment may include a hypervisor managing (spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

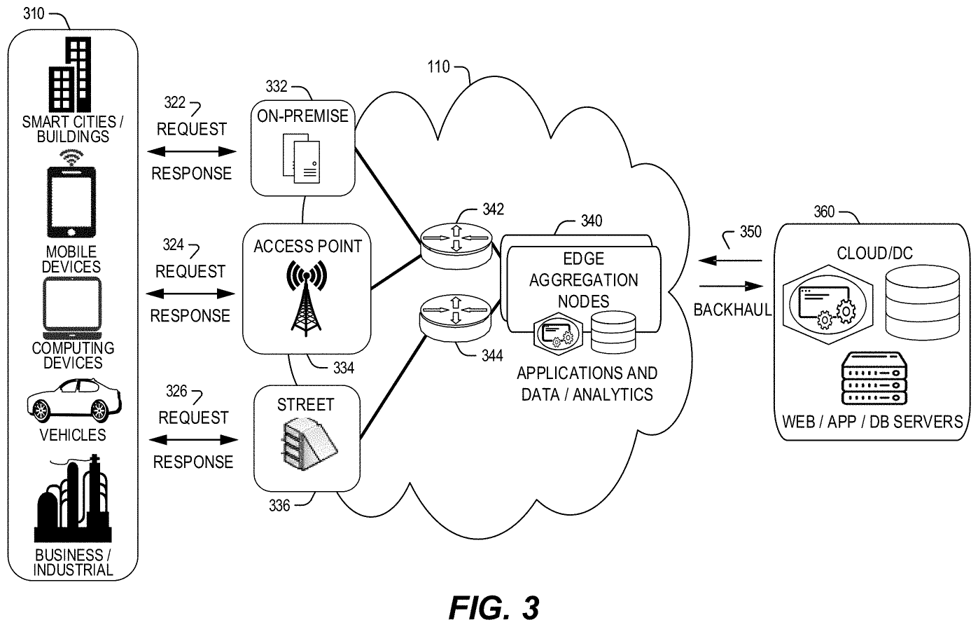

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

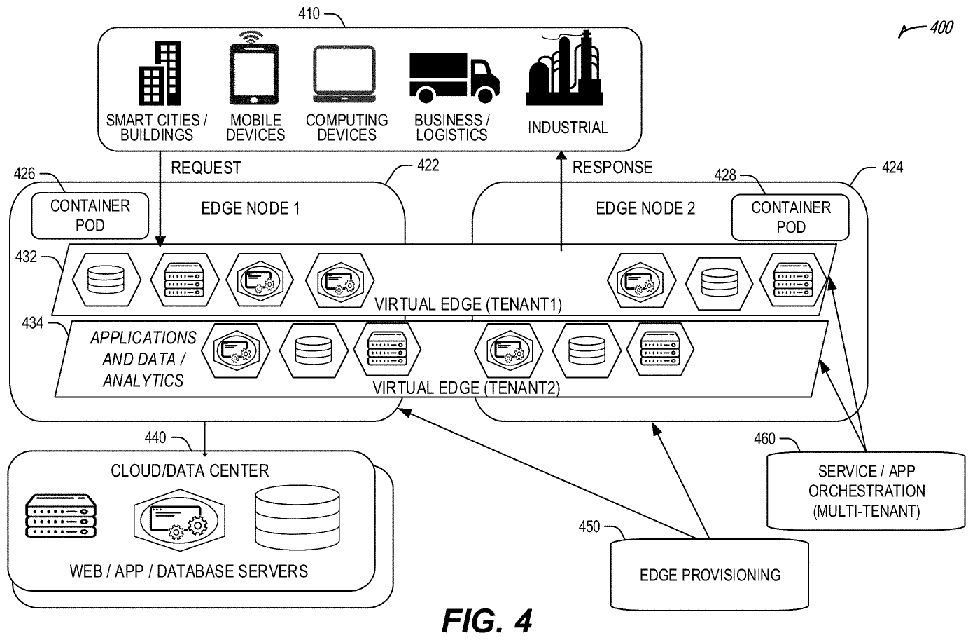

FIG. 4 illustrates deployment and orchestration for virtual edge configurations across an edge computing system operated among multiple edge nodes and multiple tenants. Specifically, FIG. 4 depicts coordination of a first edge node 422 and a second edge node 424 in an edge computing system 400, to fulfill requests and responses for various client endpoints 410 (e.g., smart cities / building systems, mobile devices, computing devices, business/logistics systems, industrial systems, etc.), which access various virtual edge instances. Here, the virtual edge instances 432, 434 provide edge compute capabilities and processing in an edge cloud, with access to a cloud/data center 440 for higher-latency requests for websites, applications, database servers, etc. However, the edge cloud enables coordination of processing among multiple edge nodes for multiple tenants or entities.

In the example of FIG. 4, these virtual edge instances include: a first virtual edge 432, offered to a first tenant (Tenant 1), which offers a first combination of edge storage, computing, and services; and a second virtual edge 434, offering a second combination of edge storage, computing, and services. The virtual edge instances 432, 434 are distributed among the edge nodes 422, 424, and may include scenarios in which a request and response are fulfilled from the same or different edge nodes. The configuration of the edge nodes 422, 424 to operate in a distributed yet coordinated fashion occurs based on edge provisioning functions 450. The functionality of the edge nodes 422, 424 to provide coordinated operation for applications and services, among multiple tenants, occurs based on orchestration functions 460.

It should be understood that some of the devices in 410 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 422, 424 may operate as security feature enforcement points for local resources allocated to multiple tenants per node. Additionally, tenant runtime and application execution (e.g., in instances 432, 434) may serve as an enforcement point for a security feature that creates a virtual edge abstraction of resources spanning potentially multiple physical hosting platforms. Finally, the orchestration functions 460 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of containers, FaaS engines, Servlets, servers, or other computation abstraction may be partitioned according to a DICE layering and fan-out structure to support a RoT context for each. Accordingly, the respective RoTs spanning devices 410, 422, and 440 may coordinate the establishment of a distributed trusted computing base (DTCB) such that a tenant-specific virtual trusted secure channel linking all elements end to end can be established.

Further, it will be understood that a container may have data or workload specific keys protecting its content from a previous edge node. As part of migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 4. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or, respective computing systems and resources which are co-owned or co-managed by multiple owners).

For instance, each edge node 422, 424 may implement the use of containers, such as with the use of a container “pod” 426, 428 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices 432, 434 are partitioned according to the needs of each container.

With the use of container pods, a pod controller oversees the partitioning and allocation of containers and resources. The pod controller receives instructions from an orchestrator (e.g., orchestrator 460) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 460 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute and a different shared pod controller is installed and invoked prior to the second pod executing.

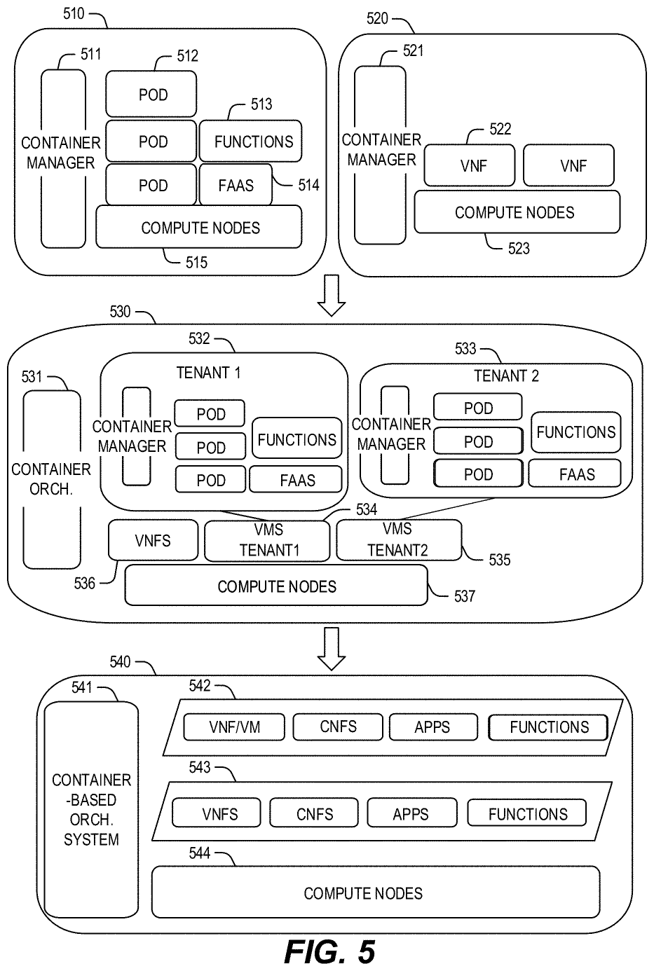

FIG. 5 illustrates additional compute arrangements deploying containers in an edge computing system. As a simplified example, system arrangements 510, 520 depict settings in which a pod controller (e.g., container managers 511, 521, and container orchestrator 531) is adapted to launch containerized pods, functions, and functions-as-a-service instances through execution via compute nodes (515 in arrangement 510), or to separately execute containerized virtualized network functions through execution via compute nodes (523 in arrangement 520). This arrangement is adapted for use of multiple tenants in system arrangement 530 (using compute nodes 537), where containerized pods (e.g., pods 512), functions (e.g., functions 513, VNFs 522, 536), and functions-as-a-service instances (e.g., FaaS instance 514) are launched within virtual machines (e.g., VMs 534, 535 for tenants 532, 533) specific to respective tenants (aside the execution of virtualized network functions). This arrangement is further adapted for use in system arrangement 540, which provides containers 542, 543, or execution of the various functions, applications, and functions on compute nodes 544, as coordinated by an container-based orchestration system 541.

The system arrangements of depicted in FIG. 5 provides an architecture that treats VMs, Containers, and Functions equally in terms of application composition (and resulting applications are combinations of these three ingredients). Each ingredient may involve use of one or more accelerator (FPGA, ASIC) components as a local backend. In this manner, applications can be split across multiple edge owners, coordinated by an orchestrator.

In the context of FIG. 5, the pod controller/container manager, container orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves and hardware partitioning schemes may be used by edge owners to enforce tenancy. Other isolation environments may include: bare metal (dedicated) equipment, virtual machines, containers, virtual machines on containers, or combinations thereof.

In further examples, aspects of software-defined or controlled silicon hardware, and other configurable hardware, may integrate with the applications, functions, and services an edge computing system. Software defined silicon may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

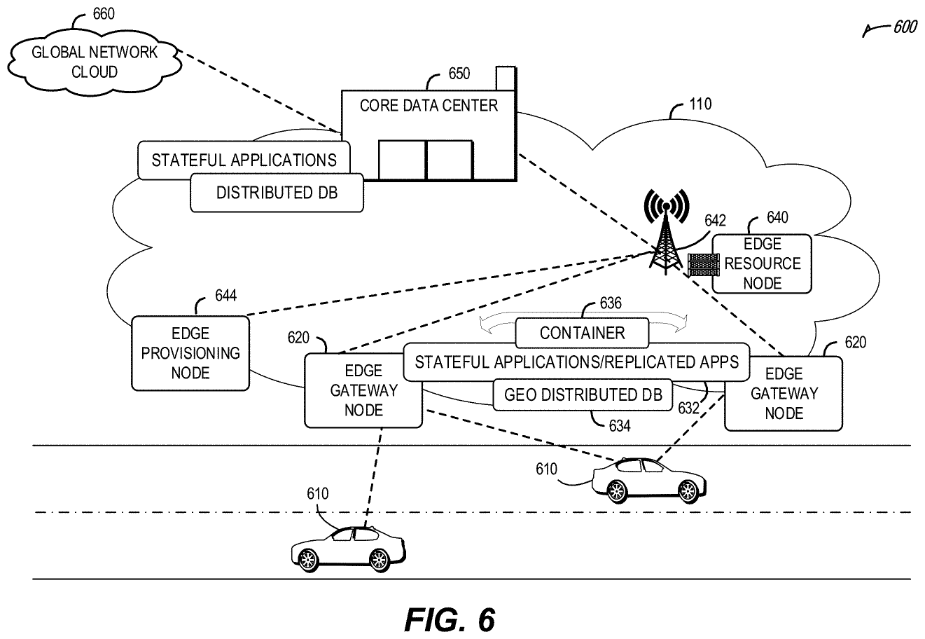

It should be appreciated that the edge computing systems and arrangements discussed herein may be applicable in various solutions, services, and/or use cases involving mobility. As an example, FIG. 6 shows a simplified vehicle compute and communication use case involving mobile access to applications in an edge computing system 600 that implements an edge cloud 110. In this use case, respective client compute nodes 610 may be embodied as in-vehicle compute systems (e.g., in-vehicle navigation and/or infotainment systems) located in corresponding vehicles which communicate with the edge gateway nodes 620 during traversal of a roadway. For instance, the edge gateway nodes 620 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 610 and a particular edge gateway device 620 may propagate so as to maintain a consistent connection and context for the client compute node 610. Likewise, mobile edge nodes may aggregate at the high priority services or according to the throughput or latency resolution requirements for the underlying service(s) (e.g., in the case of drones). The respective edge gateway devices 620 include an amount of processing and storage capabilities and, as such, some processing and/or storage of data for the client compute nodes 610 may be performed on one or more of the edge gateway devices 620.

The edge gateway devices 620 may communicate with one or more edge resource nodes 640, which are illustratively embodied as compute servers, appliances or components located at or in a communication base station 642 (e.g., a based station of a cellular network). As discussed above, the respective edge resource nodes 640 include an amount of processing and storage capabilities and, as such, some processing and/or storage of data for the client compute nodes 610 may be performed on the edge resource node 640. For example, the processing of data that is less urgent or important may be performed by the edge resource node 640, while the processing of data that is of a higher urgency or importance may be performed by the edge gateway devices 620 (depending on, for example, the capabilities of each component, or information in the request indicating urgency or importance). Based on data access, data location or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 640 also communicate with the core data center 650, which may include compute servers, appliances, and/or other components located in a central location (e.g., a central office of a cellular communication network). The core data center 650 may provide a gateway to the global network cloud 660 (e.g., the Internet) for the edge cloud 110 operations formed by the edge resource node(s) 640 and the edge gateway devices 620. Additionally, in some examples, the core data center 650 may include an amount of processing and storage capabilities and, as such, some processing and/or storage of data for the client compute devices may be performed on the core data center 650 (e.g., processing of low urgency or importance, or high complexity).

The edge gateway nodes 620 or the edge resource nodes 640 may offer the use of stateful applications 632 and a geographic distributed database 634. Although the applications 632 and database 634 are illustrated as being horizontally distributed at a layer of the edge cloud 110, it will be understood that resources, services, or other components of the application may be vertically distributed throughout the edge cloud (including, part of the application executed at the client compute node 610, other parts at the edge gateway nodes 620 or the edge resource nodes 640, etc.). Additionally, as stated previously, there can be peer relationships at any level to meet service objectives and obligations. Further, the data for a specific client or application can move from edge to edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a container 636 (or pod of containers) may be flexibly migrated from an edge node 620 to other edge nodes (e.g., 620, 640, etc.) such that the container with an application and workload does not need to be reconstituted, re-compiled, re-interpreted in order for migration to work. However, in such settings, there may be some remedial or “swizzling” translation operations applied. For example, the physical hardware at node 640 may differ from edge gateway node 620 and therefore, the hardware abstraction layer (HAL) that makes up the bottom edge of the container will be re-mapped to the physical layer of the target edge node. This may involve some form of late-binding technique, such as binary translation of the HAL from the container native format to the physical hardware format, or may involve mapping interfaces and operations. A pod controller may be used to drive the interface mapping as part of the container lifecycle, which includes migration to/from different hardware environments.

The scenarios encompassed by FIG. 6 may utilize various types of mobile edge nodes, such as an edge node hosted in a vehicle (car/truck/tram/train) or other mobile unit, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 620, some others at the edge resource node 640, and others in the core data center 650 or global network cloud 660.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center.

A trigger such as, for example, a service use case or an edge processing event, initiates the execution of the function code with the FaaS platform.

In an example of FaaS, a container is used to provide an environment in which function code (e.g., an application which may be provided by a third party) is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, container is “spun down” (e.g., deactivated and/or deallocated) on the infrastructure in response to the execution being completed.

Further aspects of FaaS may enable deployment of edge functions in a service fashion, including a support of respective functions that support edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require initialization, deployment, or configuration).

The edge computing system 600 can include or be in communication with an edge provisioning node 644. The edge provisioning node 644 can distribute software such as the example computer readable instructions 782 of FIG. 7B, to various receiving parties for implementing any of the methods described herein. The example edge provisioning node 644 may be implemented by any computer server, home server, content delivery network, virtual server, software distribution system, central facility, storage device, storage node, data facility, cloud service, etc., capable of storing and/or transmitting software instructions (e.g., code, scripts, executable binaries, containers, packages, compressed files, and/or derivatives thereof) to other computing devices. Component(s) of the example edge provisioning node 644 may be located in a cloud, in a local area network, in an edge network, in a wide area network, on the Internet, and/or any other location communicatively coupled with the receiving party(ies). The receiving parties may be customers, clients, associates, users, etc. of the entity owning and/or operating the edge provisioning node 644. For example, the entity that owns and/or operates the edge provisioning node 644 may be a developer, a seller, and/or a licensor (or a customer and/or consumer thereof) of software instructions such as the example computer readable instructions 782 of FIG. 7B. The receiving parties may be consumers, service providers, users, retailers, OEMs, etc., who purchase and/or license the software instructions for use and/or re-sale and/or sub-licensing.

In an example, edge provisioning node 644 includes one or more servers and one or more storage devices. The storage devices host computer readable instructions such as the example computer readable instructions 782 of FIG. 7B, as described below. Similarly to edge gateway devices 620 described above, the one or more servers of the edge provisioning node 644 are in communication with a base station 642 or other network communication entity. In some examples, the one or more servers are responsive to requests to transmit the software instructions to a requesting party as part of a commercial transaction. Payment for the delivery, sale, and/or license of the software instructions may be handled by the one or more servers of the software distribution platform and/or via a third party payment entity. The servers enable purchasers and/or licensors to download the computer readable instructions 782 from the edge provisioning node 644. For example, the software instructions, which may correspond to the example computer readable instructions 782 of FIG. 7B, may be downloaded to the example processor platform/s, which is to execute the computer readable instructions 782 to implement the methods described herein.

In some examples, the processor platform(s) that execute the computer readable instructions 782 can be physically located in different geographic locations, legal jurisdictions, etc. In some examples, one or more servers of the edge provisioning node 644 periodically offer, transmit, and/or force updates to the software instructions (e.g., the example computer readable instructions 782 of FIG. 7B) to ensure improvements, patches, updates, etc. are distributed and applied to the software instructions implemented at the end user devices. In some examples, different components of the computer readable instructions 782 can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

In further examples, any of the compute nodes or devices discussed with reference to the present edge computing systems and environment may be fulfilled based on the components depicted in FIGS. 7A and 7B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 7A, an edge compute node 700 includes a compute engine (also referred to herein as “compute circuitry”) 702, an input/output (I/O) subsystem 708, data storage 710, a communication circuitry subsystem 712, and, optionally, one or more peripheral devices 714. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 700 may be embodied as any type of engine, device, or collection of devices capable of performing various compute functions. In some examples, the compute node 700 may be embodied as a single device such as an integrated circuit, an embedded system, a field-programmable gate array (FPGA), a system-on-a-chip (SOC), or other integrated system or device. In the illustrative example, the compute node 700 includes or is embodied as a processor 704 and a memory 706. The processor 704 may be embodied as any type of processor capable of performing the functions described herein (e.g., executing an application). For example, the processor 704 may be embodied as a multi-core processor(s), a microcontroller, a processing unit, a specialized or special purpose processing unit, or other processor or processing/controlling circuit.

In some examples, the processor 704 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 704 may work in coordination with each other to execute many types of operations and instructions within and on behalf of the compute node 700.

The memory 706 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 706 may be integrated into the processor 704. The memory 706 may store various software and data used during operation such as one or more applications, data operated on by the application(s), libraries, and drivers.

The compute circuitry 702 is communicatively coupled to other components of the compute node 700 via the I/O subsystem 708, which may be embodied as circuitry and/or components to facilitate input/output operations with the compute circuitry 702 (e.g., with the processor 704 and/or the main memory 706) and other components of the compute circuitry 702. For example, the I/O subsystem 708 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 708 may form a portion of a system-on-a-chip (SoC) and be incorporated, along with one or more of the processor 704, the memory 706, and other components of the compute circuitry 702, into the compute circuitry 702.

The one or more illustrative data storage devices 710 may be embodied as any type of devices configured for short-term or long-term storage of data such as, for example, memory devices and circuits, memory cards, hard disk drives, solid-state drives, or other data storage devices. Individual data storage devices 710 may include a system partition that stores data and firmware code for the data storage device 710. Individual data storage devices 710 may also include one or more operating system partitions that store data files and executables for operating systems depending on, for example, the type of compute node 700.

The communication circuitry 712 may be embodied as any communication circuit, device, or collection thereof, capable of enabling communications over a network between the compute circuitry 702 and another compute device (e.g., an edge gateway of an implementing edge computing system). The communication circuitry 712 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 712 includes a network interface controller (NIC) 720, which may also be referred to as a host fabric interface (HFI). The NIC 720 may be embodied as one or more add-in-boards, daughter cards, network interface cards, controller chips, chipsets, or other devices that may be used by the compute node 700 to connect with another compute device (e.g., an edge gateway node). In some examples, the NIC 720 may be embodied as part of a system-on-a-chip (SoC) that includes one or more processors, or included on a multichip package that also contains one or more processors. In some examples, the NIC 720 may include a local processor (not shown) and/or a local memory (not shown) that are both local to the NIC 720. In such examples, the local processor of the NIC 720 may be capable of performing one or more of the functions of the compute circuitry 702 described herein. Additionally, or alternatively, in such examples, the local memory of the NIC 720 may be integrated into one or more components of the client compute node at the board level, socket level, chip level, and/or other levels.

Additionally, in some examples, a respective compute node 700 may include one or more peripheral devices 714. Such peripheral devices 714 may include any type of peripheral device found in a compute device or server such as audio input devices, a display, other input/output devices, interface devices, and/or other peripheral devices, depending on the particular type of the compute node 700. In further examples, the compute node 700 may be embodied by a respective edge compute node (whether a client, gateway, or aggregation node) in an edge computing system or like forms of appliances, computers, subsystems, circuitry, or other components.

In a more detailed example, FIG. 7B illustrates a block diagram of an example of components that may be present in an edge computing node 750 for implementing the techniques (e.g., operations, processes, methods, and methodologies) described herein. This edge computing node 750 provides a closer view of the respective components of node 700 when implemented as or as part of a computing device (e.g., as a mobile device, a base station, server, gateway, etc.). The edge computing node 750 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 750, or as components otherwise incorporated within a chassis of a larger system.

The edge computing device 750 may include processing circuitry in the form of a processor 752, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 752 may be a part of a system on a chip (SoC) in which the processor 752 and other components are formed into a single integrated circuit, or a single package, such as the Edison™ or Galileo™ SoC boards from Intel Corporation, Santa Clara, Calif. As an example, the processor 752 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, California, a MIPS®-based design from MIPS Technologies, Inc. of Sunnyvale, California, an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 752 and accompanying circuitry may be provided in a single socket form factor, multiple socket form factor, or a variety of other formats, including in limited hardware configurations or configurations that include fewer than all elements shown in FIG. 7B.

The processor 752 may communicate with a system memory 754 over an interconnect 756 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDlMMs or MiniDIMMs.

To provide for persistent storage of information such as data, applications, operating systems and so forth, a storage 758 may also couple to the processor 752 via the interconnect 756. In an example, the storage 758 may be implemented via a solid-state disk drive (SSDD). Other devices that may be used for the storage 758 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 758 may be on-die memory or registers associated with the processor 752. However, in some examples, the storage 758 may be implemented using a micro hard disk drive (HDD). Further, any number of new technologies may be used for the storage 758 in addition to, or instead of, the technologies described, such resistance change memories, phase change memories, holographic memories, or chemical memories, among others.

The components may communicate over the interconnect 756. The interconnect 756 may include any number of technologies, including industry standard architecture (ISA), extended ISA (EISA), peripheral component interconnect (PCI), peripheral component interconnect extended (PCIx), PCI express (PCIe), or any number of other technologies. The interconnect 756 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 756 may couple the processor 752 to a transceiver 766, for communications with the connected edge devices 762. The transceiver 766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 762. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 766 (or multiple transceivers) may communicate using multiple standards or radios for communications at a different range. For example, the edge computing node 750 may communicate with close devices, e.g., within about 10 meters, using a local transceiver based on Bluetooth Low Energy (BLE), or another low power radio, to save power. More distant connected edge devices 762, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 766 (e.g., a radio transceiver) may be included to communicate with devices or services in the edge cloud 795 via local or wide area network protocols. The wireless network transceiver 766 may be a low-power wide-area (LPWA) transceiver that follows the IEEE 802.15.4, or IEEE 802.15.4g standards, among others. The edge computing node 750 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 766, as described herein. For example, the transceiver 766 may include a cellular transceiver that uses spread spectrum (SPA/SAS) communications for implementing high-speed communications. Further, any number of other protocols may be used, such as Wi-Fi® networks for medium speed communications and provision of network communications. The transceiver 766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 768 may be included to provide a wired communication to nodes of the edge cloud 795 or to other devices, such as the connected edge devices 762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 768 may be included to enable connecting to a second network, for example, a first NIC 768 providing communications to the cloud over Ethernet, and a second NIC 768 providing communications to other devices over another type of network.

Given the variety of types of applicable communications from the device to another component or network, applicable communications circuitry used by the device may include or be embodied by any one or more of components 764, 766, 768, or 770. Accordingly, in various examples, applicable means for communicating (e.g., receiving, transmitting, etc.) may be embodied by such communications circuitry.

The edge computing node 750 may include or be coupled to acceleration circuitry 764, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 756 may couple the processor 752 to a sensor hub or external interface 770 that is used to connect additional devices or subsystems. The devices may include sensors 772, such as accelerometers, level sensors, flow sensors, optical light sensors, camera sensors, temperature sensors, global navigation system (e.g., GPS) sensors, pressure sensors, barometric pressure sensors, and the like. The hub or interface 770 further may be used to connect the edge computing node 750 to actuators 774, such as power switches, valve actuators, an audible sound generator, a visual warning device, and the like.

In some optional examples, various input/output (I/O) devices may be present within or connected to, the edge computing node 750. For example, a display or other output device 784 may be included to show information, such as sensor readings or actuator position. An input device 786, such as a touch screen or keypad may be included to accept input. An output device 784 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 750. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 776 may power the edge computing node 750, although, in examples in which the edge computing node 750 is mounted in a fixed location, it may have a power supply coupled to an electrical grid, or the battery may be used as a backup or for temporary capabilities. The battery 776 may be a lithium ion battery, or a metal-air battery, such as a zinc-air battery, an aluminum-air battery, a lithium-air battery, and the like.

A battery monitor/charger 778 may be included in the edge computing node 750 to track the state of charge (SoCh) of the battery 776, if included. The battery monitor/charger 778 may be used to monitor other parameters of the battery 776 to provide failure predictions, such as the state of health (SoH) and the state of function (SoF) of the battery 776. The battery monitor/charger 778 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 778 may communicate the information on the battery 776 to the processor 752 over the interconnect 756. The battery monitor/charger 778 may also include an analog-to-digital (ADC) converter that enables the processor 752 to directly monitor the voltage of the battery 776 or the current flow from the battery 776. The battery parameters may be used to determine actions that the edge computing node 750 may perform, such as transmission frequency, mesh network operation, sensing frequency, and the like.

A power block 780, or other power supply coupled to a grid, may be coupled with the battery monitor/charger 778 to charge the battery 776. In some examples, the power block 780 may be replaced with a wireless power receiver to obtain the power wirelessly, for example, through a loop antenna in the edge computing node 750. A wireless battery charging circuit, such as an LTC4020 chip from Linear Technologies of Milpitas, California, among others, may be included in the battery monitor/charger 778. The specific charging circuits may be selected based on the size of the battery 776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 758 may include instructions 782 in the form of software, firmware, or hardware commands to implement the techniques described herein. Although such instructions 782 are shown as code blocks included in the memory 754 and the storage 758, it may be understood that any of the code blocks may be replaced with hardwired circuits, for example, built into an application specific integrated circuit (ASIC).

In an example, the instructions 782 provided via the memory 754, the storage 758, or the processor 752 may be embodied as a non-transitory, machine-readable medium 760 including code to direct the processor 752 to perform electronic operations in the edge computing node 750. The processor 752 may access the non-transitory, machine-readable medium 760 over the interconnect 756. For instance, the non-transitory, machine-readable medium 760 may be embodied by devices described for the storage 758 or may include specific storage units such as optical disks, flash drives, or any number of other hardware devices.

The non-transitory, machine-readable medium 760 may include instructions to direct the processor 752 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 782 on the processor 752 (separately, or in combination with the instructions 782 of the machine readable medium 760) may configure execution or operation of a trusted execution environment (TEE) 790. In an example, the TEE 790 operates as a protected area accessible to the processor 752 for secure execution of instructions and secure access to data. Various implementations of the TEE 790, and an accompanying secure area in the processor 752 or the memory 754 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 750 through the TEE 790 and the processor 752.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

FIG. 7C illustrates an example software distribution platform 735 to distribute software, such as the example computer readable instructions 782 of FIG. 7B, to one or more devices, such as example processor platform(s) 735 and/or example connected Edge devices 310 of FIG. 3. The example software distribution platform 735 may be implemented by any computer server, data facility, cloud service, etc., capable of storing and transmitting software to other computing devices (e.g., third parties, the example connected Edge devices 310 of FIG. 3). Example connected Edge devices may be customers, clients, managing devices (e.g., servers), third parties (e.g., customers of an entity owning and/or operating the software distribution platform 735). Example connected Edge devices may operate in commercial and/or home automation environments. In some examples, a third party is a developer, a seller, and/or a licensor of software such as the example computer readable instructions 782 of FIG. 7B. The third parties may be consumers, users, retailers, OEMs, etc., that purchase and/or license the software for use and/or re-sale and/or sub-licensing. In some examples, distributed software causes display of one or more user interfaces (UIs) and/or graphical user interfaces (GUIs) to identify the one or more devices (e.g., connected Edge devices) geographically and/or logically separated from each other (e.g., physically separated IoT devices chartered with the responsibility of water distribution control (e.g., pumps), electricity distribution control (e.g., relays), etc.).

In the illustrated example of FIG. 7C, the software distribution platform 735 includes one or more servers and one or more storage devices. The storage devices store the computer readable instructions 782, which may correspond to the example computer readable instructions, as described above. The one or more servers of the example software distribution platform 735 are in communication with a network 730, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or via a third-party payment entity. The servers enable purchasers and/or licensors to download the computer readable instructions 782 from the software distribution platform 735. For example, the software, which may correspond to the example computer readable instructions, may be downloaded to the example processor platform(s) 735 (e.g., example connected Edge devices), which is/are to execute the computer readable instructions 782 to implement the transparent dynamic reassembly of computing resource compositions. In some examples, one or more servers of the software distribution platform 735 are communicatively connected to one or more security domains and/or security devices through which requests and transmissions of the example computer readable instructions 782 must pass. In some examples, one or more servers of the software distribution platform 735 periodically offer, transmit, and/or force updates to the software (e.g., the example computer readable instructions 782 of FIG. 7B) to ensure improvements, patches, updates, etc., are distributed and applied to the software at the end user devices.

In the illustrated example of FIG. 7C, the computer readable instructions 782 are stored on storage devices of the software distribution platform 735 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 782 stored in the software distribution platform 735 are in a first format when transmitted to the example processor platform(s) 735. In some examples, the first format is an executable binary in which particular types of the processor platform(s) 735 can execute. However, in some examples, the first format is uncompiled code that requires one or more preparation tasks to transform the first format to a second format to enable execution on the example processor platform(s) 735. For instance, the receiving processor platform(s) 735 may need to compile the computer readable instructions 782 in the first format to generate executable code in a second format that is capable of being executed on the processor platform(s) 735. In still other examples, the first format is interpreted code that, upon reaching the processor platform(s) 735, is interpreted by an interpreter to facilitate execution of instructions.

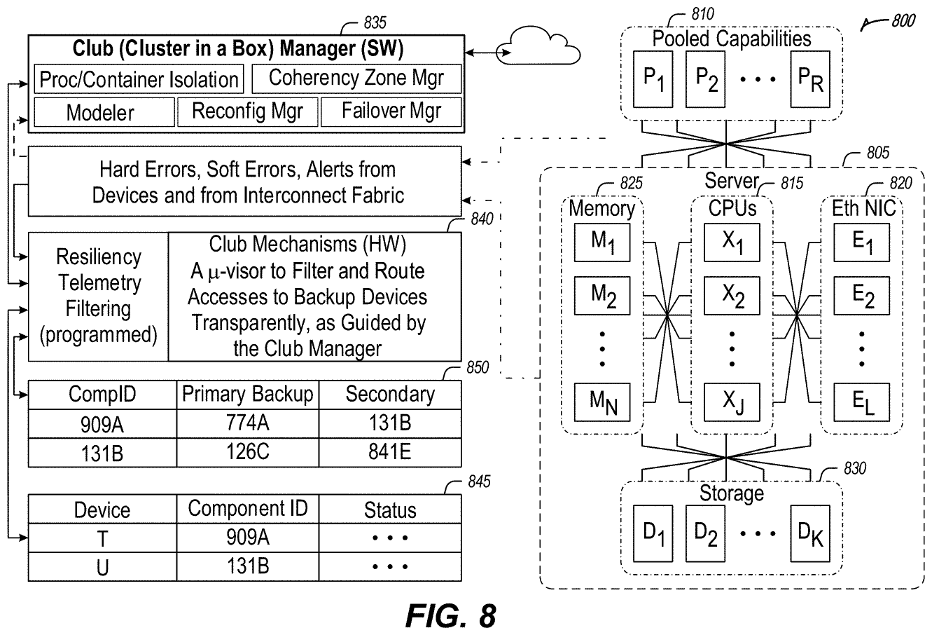

FIG. 8 is a block diagram of an example of a system 800 for transparent dynamic reassembly of computing resource compositions, according to an embodiment. FIG. 8 shows an architecture and components for facilitation of resilience through recomposability and redundancy among components.

The system 800 includes a server 805 and its organization, pooled capabilities 810. The server 805 includes XPUs 815 (e.g., CPUs, GPUs, etc.), ethernet PF/VFs 820, memory modules 825 (e.g., DIMMs, non-volatile DIMMSs (NVDIMMs), etc.), and storage devices 830.

The pooled capabilities 810 include various rack-level/sub-rack level resources that are available for dynamic course-grained allocation and sharing among servers and may include pooled memory, pooled fixed-function accelerator units, pooled field-programmable gate arrays (FPGAs), etc. that may be interconnected with one another and with servers such as server 805 over compute express links (CXLs) and switches. In an example, the pooled capabilities 810 may be shared by multiple CLUB managers such as CLUB manager 835 where they may coordinate with each other over the network and maximize utilization of resources based on current and predicted resiliency need.

The XPUs 815, the ethernet PF/VFs 820, the memory modules 825, the storage devices 930, and the pooled capabilities 810 may be collectively referred to as devices. The devices are accessible from the server 805 and are interlinked by various buses (e.g., channels). The buses form a resilient mesh that may be reconfigured on demand in the event of a malfunction in a point-to-point link among the buses. The devices and the meshes or collections of buses that interconnect them are configurable dynamically. There are a set of configuration resources (such as registers) (not shown) that may be set or cleared in order to include or exclude a component and a link in a communication mesh into an active set. Components in the active set (including the links that physically connect some subset of them) may be programmed.

A microvisor entity acts as a hardware embedded hypervisor for managing how resources are named and how they communicate with one another on the basis of those names. The microvisor may be implemented in an infrastructure processing unit (IPU), may be within a platform CPUs as a hardware logic block, in a management controller such as a baseband management controller (BMC), or in an engine such as a management engine. The microvisor is implementation specific and is not meant to be architecturally exposed to general application programs or to operating systems software. The microvisor operations are of interest to platform firmware which is implementation specific, and to the CLUB manager 835.

While the microvisor may be controlled/guided by platform firmware, it also includes a large body of its implementation logic already preprogrammed for agility and for keeping it largely outside any possibility of an attack or compromise of function. Because it is preprogrammed, it is exhaustively tested ahead of time for robustness. In an example, the microvisor may be mirrored by a second, equally capable but likely economized (e.g., less performance, etc.), shadow microvisor that activates itself if it senses that the primary microvisor has encountered an error. This sensing may be performed by setting up a heartbeat sequence in hardware. The microvisor appears to the rest of the system 800 as a single entity whether the primary microvisor or the shadow microvisor is in operation. In an example, multiple distributed microvisors may form a microvisor cluster with full-mesh logical connectivity between them while exposing a single microvisor to the rest of the system 800 making the microvisor a fully resilient component.

The microvisor controls which components of the server 805 and of the pooled entities 810 beyond the server 805 are active in a single logical composition. One or more component devices may be made inactive by the microvisor in a given composition of the logical server. Components that are made active or inactive include buses or the links among them. For example, if P7 is a path between two devices D8 and E9, and link L10 of the links on P7 exhibits a high error rate, then the microvisor computes a new optimal path Q7 that connects D8 to E9 where Q7 contains other links and not link L10. The microvisor reconfigures the routing elements so that flows along P7 become routed to follow path Q7.

This programmability of active devices and which links carry communications between them allows the server 805 to be composable at the hardware level, out of the various devices, and it allows the communication methods at the hardware level to be programmed to route data and control signals between the various devices that constitute the server 805. The server internal devices and the pooled server external devices act collectively as a programmable cluster to form a cluster in a box (CLUB).

Programmability further permits a device to be aliased, so that, for example, a physical link L1 between two devices Ux and Vy may communicate between Ux and Vy. Link L1 may be reprogrammed on demand by the microvisor so that it may be treated as a combination of two or more links, L1a, L1b, etc. The link L1 a conducts traffic flowing between Ux and Vy just as the original link L1 did and link L1b conducts traffic flowing between Ux and Wz where Wz is an alias of Vy, and L1c conducts traffic flowing between Vy and Wz (e.g., link L1c is virtual in that it is supporting traffic between Vy and itself since Wz is an alias of Vy).

The hardware in the server 805 and in the pooled capabilities 810 monitors health signals, data integrity errors, and other metrics, timestamps them and places them in a circular log in a reserved area of memory. The microvisor may perform various fixed and programmable filtering operations on these metrics.

The CLUB manager 835 performs a number of functions. The CLUB manager 835 acts as a platform level resiliency orchestrator. It takes notice of failure events, soft errors (e.g., predictive or correlated to failures), probabilistic indications of security issues. For example, abnormal changes in traffic patterns to/from a device, abnormal utilization changes at a device, etc. may suggest a denial of service (DoS) attack, a virus, a worm, etc. The CLUB manager 835 filters failure events to determine whether and what type of cluster reconfiguration, data isolation, or operation sandboxing actions are warranted.

The CLUB manager 835 may be a software component that is trusted and is pre-authenticated through server 805 boot flows as the first software component (e.g., in the trust chain between the hypervisor or host OS and hardware). The CLUB manager 835 is pre-validated with the microvisor and is self-contained (e.g., does not need services of a software VMM or an OS and is launched by the microvisor).

The microvisor may be part of a CLUB mechanisms hardware 840. The microvisor filters various resiliency related statistics and places the filtered results (which may be several orders of magnitude more compact than the raw statistics), into another circular log in reserved physical memory. The CLUB manager 835 processes the resiliency related statistics and determines the type of reconfiguration to perform and pre- and post- reconfiguration actions to take. For the CLUB mechanisms hardware 840 level actions, it communicates (synchronously) with the microvisor. Some of the pre- and post-reconfiguration actions may coordinate with application, OS, and VMM software.

Data structures or databases (or other schemas) represent configuration information that is used for coordinating between the CLUB manager 835 and the microvisor. A first structure 845 maintains the identifiers of various devices and their statuses. A second structure 850 maintains information about primary and secondary devices or device components that may be selected for each device. When a device D with higher than normal failure or error signals is identified, D is replaced by a primary backup device P, and a role of the primary backup may be given to a pre-identified secondary device S. A new secondary device is then identified. Identification of the secondary device may be performed in the background and ahead of when it (the secondary device) enters the role of the primary backup device. At the same time, in strict resiliency scenarios, the new secondary device is enabled and set active at the same time as the primary device to minimize effects of a double failure (e.g., the old primary and the new primary failed within a short period of time). The microvisor may maintain a list of devices in a warm state in order to reconfigure the system 800 with the lowest latency possible.

Hardware (e.g., microvisor, server 805, pooled resources 810, etc.) provides for asynchronous streaming of updates among data storage devices 830 and their backup devices. If D (and hence P, S) are memory devices 825 or storage devices 830, then updates made to D are copied on a periodic or streaming basis to P and S. Depending on implementation, a device may expose information to be synchronized with backup devices. For example, by exposing a memory area for committed updates/logs and semaphore(s) to signal the information being updated.

If this capability is not present in a given implementation at the hardware level, it may be provided for at a software level by periodic capture and propagation of rolling delta-checkpoints. Whether supported in hardware or software, the time required to synchronize between data contents of D and those of backups P, S is ensured to be small (e.g., milliseconds).

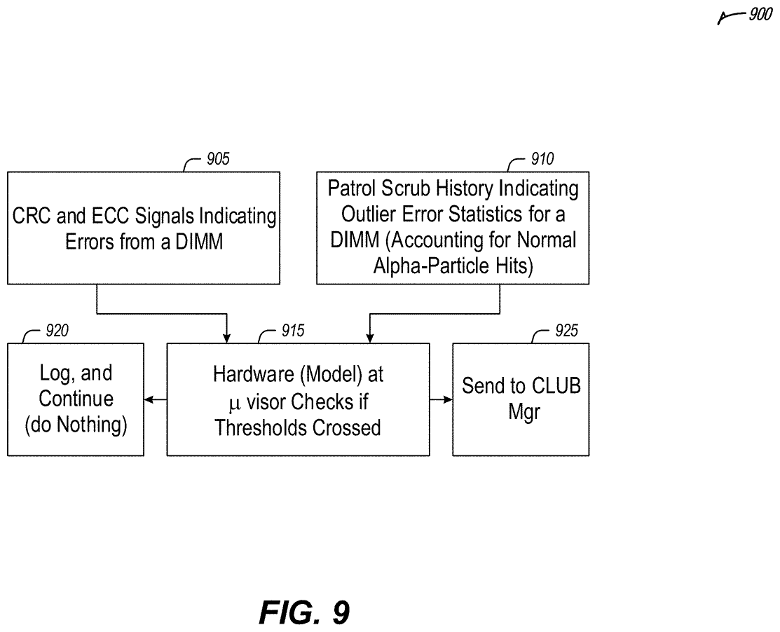

FIG. 9 illustrates a data flow diagram of an example of an error indicator flow 900 for transparent dynamic reassembly of computing resource compositions, according to an embodiment. The data flow 900 illustrates an example where resiliency concerns memory DIMM robustness. Other device types have similar data flows. Error monitoring hardware forwards two groups of errors or faulty indications to the log that the microvisor looks at. A first error group 905 is an in band error group indicating CRC or ECC detections. A second error group 910 includes errors identified by patrol scrubbing from double data rate (DDRx) DIMMs. Another example of partial DIMM failure (not shown) may be when some ranks/layers of 3D memory generate errors because of insufficient cooling. In a partial failure, the microvisor may initiate actions for components (e.g., hypervisor, OS, application, etc.) that resided in the affected ranks/layers.

The first error group 905 and the second error group 910 are evaluated by the microvisor. It applies a model 915 (e.g., a classic decision tree, etc.) to determine whether to log the overall fragility indicator of the DIMM into a durable log 920 or to alert the CLUB manager (e.g., at operation 925). It may choose to do both logging and alerting.

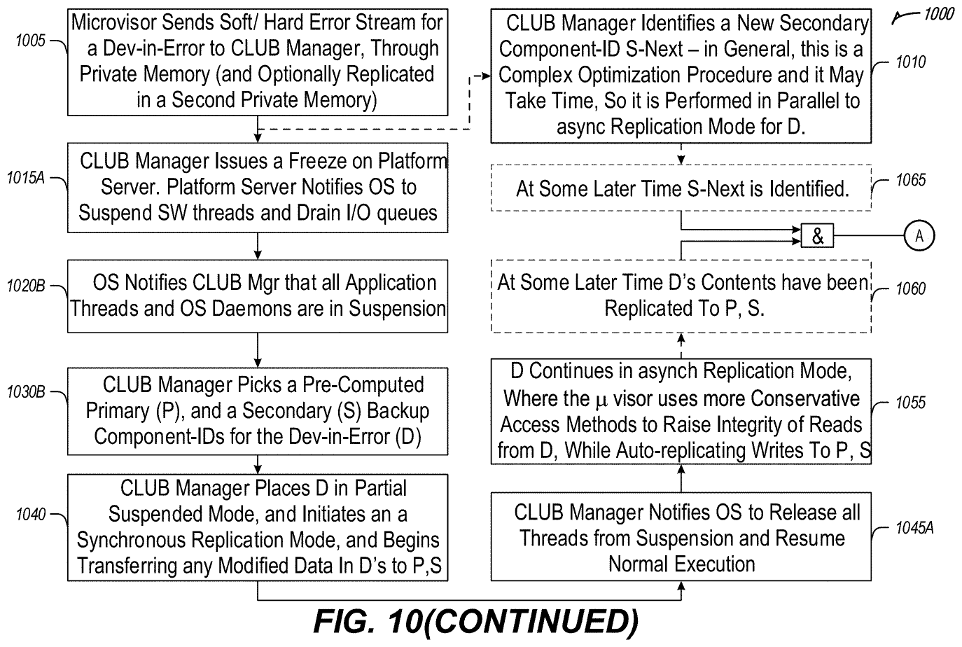

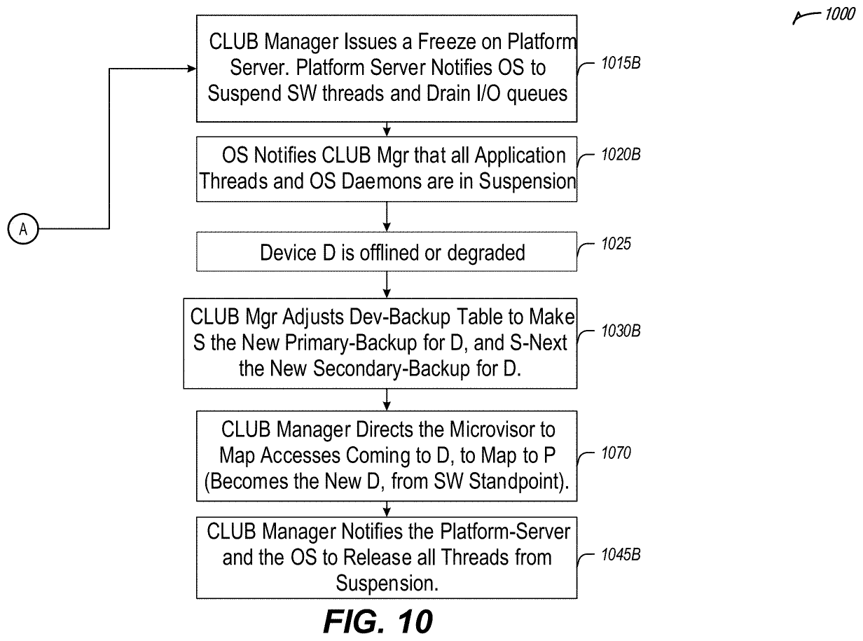

FIG. 10 illustrates a flow chart for an example of a process 1000 for a cluster in a box manager for transparent dynamic reassembly of computing resource compositions, according to an embodiment. The process 1000 describes how the CLUB manager works with the other components in the system to achieve reconfiguration, and to prepare for future reconfiguration.

The microvisor notifies and shares with the CLUB manager various outlier behaviors indicating that a device is in need of attention due to high error rates, possible security compromise, or some other evidence of erratic behavior (e.g., at operation 1005). The CLUB manager initiates a background search to identify, a third backup device for the device in error (e.g., at operation 1010). A primary and a secondary backup device were previously identified for the device in error. The background search for a third backup device may take some time (e.g., several hundreds of microseconds or milliseconds) so it is performed in the background in parallel with other foreground operations.

In an example, the backup devices may be periodically polled or otherwise verified to determine that the backup devices are available to serve backup roles. For example, a previously identified backup device may go offline, may be replaced by another device, etc. If the polling identifies that a backup device is no longer available, a search for a replacement backup device may be conducted and/or, a secondary, tertiary, etc. backup device may be promoted. A search for a replacement for the promoted device may be undertaken to ensure that full redundancy is in place in the event of a single failure or multiple failures. In an example, the polling frequency may be based on an SLA or other metric that corresponds with a resiliency requirement for the environment in which the devices are operating. For example, a microservice may have an SLA that indicates high criticality leading the polling frequency to be increased while a video streaming service may have an SLA that indicates best effort delivery leading the polling frequency to decrease.

In the foreground, the microvisor issues a freeze request to the platform server software (e.g., the VMM, various VMs, containers, etc.(e.g., at operation 1015A). The freeze request may include save-state-and-shutdown for some services that may be restarted later. The freeze request allows any I/O operations that are enqueued or in progress to drain (e.g., complete). The OS/VMM reports back to the CLUB manager that all other software (except the CLUB manager itself) have checked into a freeze barrier (e.g., at operation 1020A), and having so reported, the OS/VMM also enters a busy-wait, do-nothing loop. The software execution of the server is fully suspended and its processor caches have been flushed to memory (e.g., at operation 1025).

The CLUB manager prepares to effect a transition from failing device D to its primary backup P (e.g., as identified at operation 1030A), and to make the secondary backup device S (e.g., as identified at operation 1030A) the new primary backup device. If the device type of D is not memory or storage, then the transition is nearly immediate as it may be performed synchronously (e.g., device D may have some of its own internal state) (e.g., at operation 1040). If D has local memory and the local memory based state needs to be synchronized with the primary device then D is handled like a memory or storage device. D and P may register a mode with the CLUB manager so that P may take over for D immediately and D becomes available to P as a hidden device and goes offline once replication from D to P completes. Otherwise, the CLUB manager initiates a backup sync between D, P, and S, (e.g., at operation 1030) and will proceed in the background after the CLUB manager has released the server from the freeze (e.g., at operation 1045A). Before the CLUB manager releases the server, it places D in a conservative mode of operation (e.g., at operation 1055) in which writes/stores to D are automatically intercepted by the server and relayed to P, and S,(e.g., at operation 1040) and reads from D are performed with more relaxed (e.g., expanded) timing and, or, higher power budget. For example, reduced bandwidth and increased latency may be implemented to ensure a high level of integrity.

P and S become synchronized with D and role transition from P to S and from D to P may take effect (e.g., at operation 1060). The transition will go into effect after a new secondary that may replace S has been identified (e.g., at operation 1065).

When D, P, and S are in sync, and a new secondary backup, S-next has been identified (e.g., at operation 1065) the CLUB manager again puts the server into a freeze (At operation 1015B), and when the freeze is effective, and the OS/VMM again reports back to the CLUB manager that all other software (except the CLUB manager itself) have checked into a freeze barrier (e.g., at operation 1020B), device D is taken offline or placed into a degraded state (e.g., for reduced intensity workloads, workloads with reduced service level agreement (SLA) requirements, etc.) (e.g., at operation 1025). The microvisor reconfigures the routing and device identities map (e.g., at operation 1070) so that the identity of D is absorbed by P (e.g., accesses targeting D automatically map to device/component P), the identity of P is absorbed by S, and the identity of S is absorbed by S-next. The CLUB manager resumes the server (e.g. at operation 1045B).

The process 1000 is also applicable where applications are running on a cluster/rack managed by a CLUB manager, CLUB A and accessing remote resources (e.g., memory read/write via remote direct memory access (RDMA) NIC) managed by another manager, CLUB B. If one or multiple remote resources (e.g., RDMA NIC and memory region, etc.) experience an error, their local microvisor may detect the error and may contact the local CLUB manager (CLUB B) to find an alternate configuration. While CLUB B is restoring a working configuration, a critical application transaction associated to the affected memory might fail. CLUB B may notify CLUB A about the error and CLUB A may perform precautionary actions (e.g., freezing transaction requests etc.).

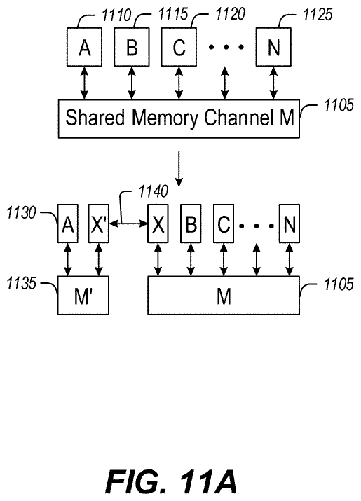

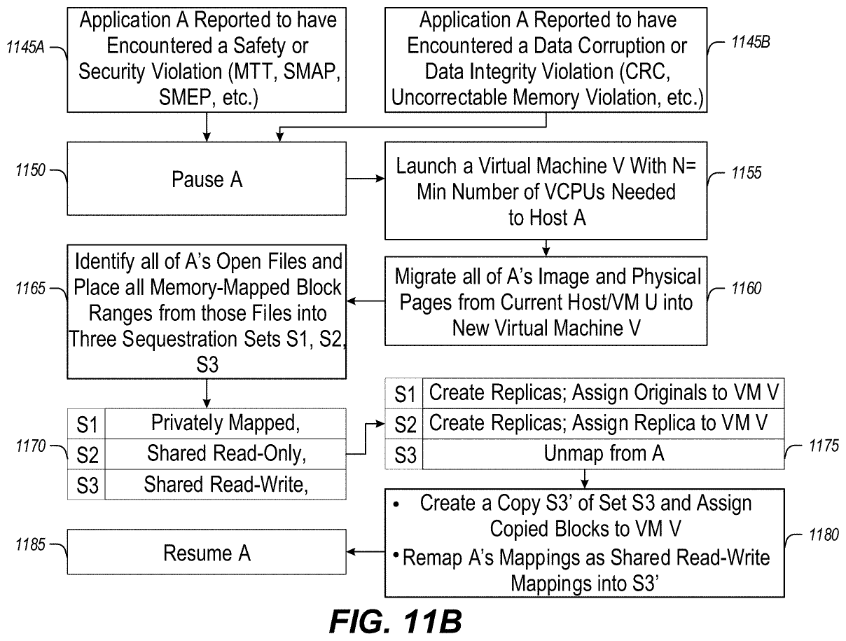

FIGS. 11A and 11B illustrate an example of a transformation of a computing resource composition for transparent dynamic reassembly of computing resource compositions, according to an embodiment. FIGS. 11A and 11B illustrate a data flow for shared memory based socket or other network based transport hardening. When a fragility (e.g., error, degradation, etc.) arises in an application A that has message passing calls (e.g., GOOGLE® remote procedure call (gRPC), etc.) with other applications B, C, D, implemented on top of shared memory channels, a default action may be to terminate A. That may not be the most effective action. For example, A may be performing a critical service and terminating A abruptly may cause other dependent services and programs to crash, hang, or produce undefined behavior. A more effective action may be to follow a recovery process in which A is permitted to continue with some capabilities being restricted. For example, A may continue but may no longer accept new service connections but may accept connections from an administrative service.

In FIG. 11A, M represents a shared memory channel 1105 (e.g., page cache pages, etc.) that is shared between application A 1110, application B 1115, application C 1120, etc., to application N 1125 as a means of transport. Monitoring of application A 1110 by a library or by safety/security hooks in hardware produces an indication that the execution of application A 1110 is susceptible to pointer overruns or some other memory safety violations. Application A is isolated 1130 into a separate virtual machine that alters a page map of application A 1110 to redirect its updates from shared pages in M to a set of pages M′ 1135 that are not shared. A transparent bridge 1140 is created (shown by X and X′ processes). The transparent bridge 1140 moves data explicitly through checked (e.g., verified) copying between M and M′. Application A 1110, application B 1115, application C 1120, and application N 1125 continue to run but the stores of application A 1130 are not visible to application B 1115, application C 1120, and application N 1125, until the stores have been proved not to have buffer overruns.

FIG. 11B illustrates a flow of actions behind the transformation shown in FIG. 11A. A violation is reported for application A 1110 (e.g., at operation 1145A and/or 1145B). Application A 1110 is paused (e.g., at operation 1150) when it either encounters a hardware checked safety or security problem during its memory accesses (which may happen anywhere in the address space of application A 1110 and not just in a shared memory segment) or when memory accesses of application a 1110 indicate cyclic redundancy check (CRC) or some other violation that may indicate a potential integrity violation, a man-in-the-middle (MITM) attack, etc. After pausing application A 1110, the CLUB manager launches a new virtual machine (e.g., at operation 1155) on the same or some other host. The CLUB manager assigns a bare minimum number of logical CPUs to the virtual machine. The CLUB manager then migrates application A 1110 into the newly created VM (e.g., at operation 1160), with the privately mapped pages of application A 1110 assigned to the new VM with an optional checkpoint on storage so that debugging/tracing may be supported at a later time. For shared pages, the new VM for application A 1110 is given a copy and the bridge endpoint X′ shared-memory-maps those pages (e.g., pages 1170) with application A 1110 (e.g., at operation 1165). Additionally, since pages that A has in shared R/W mode may be possibly corrupted by application A 1110, a snapshot of those shared R/W pages is also optionally preserved on storage, for later examination. The other endpoint of the bridge, X, has the same mapped view of shared pages (e.g., pages 1175) in memory that application A 1110 had. The endpoint gets a filtered view of updates by application A 1110 to shared memory (which is now shared only between A and X′, and X′ funnels only those modifications into X (e.g., at operation 1180) that the original permissions of application A 1110 (reflected into X) would have permitted. This allows application A 1110 to continue communicating with application B 1115, application C 1120, and application N 1125 (e.g., at operation 1185) in a gracefully degraded mode where it cannot perform operations that an administrative control determines are prohibited.

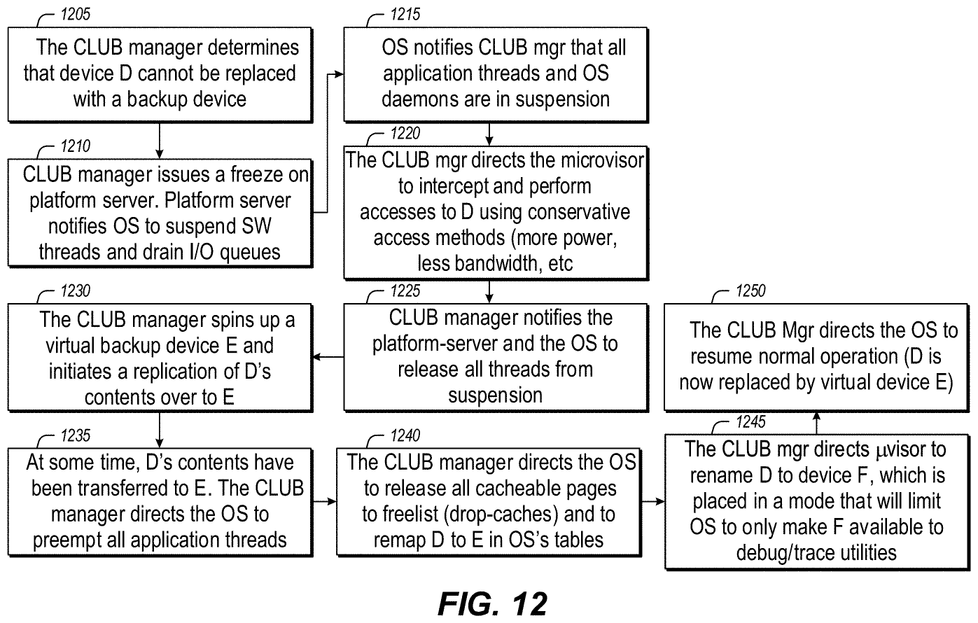

FIG. 12 illustrates a flow chart of an example of a process 1200 for device virtualization through agency of operating system/virtual machine manager software by a cluster in a box manager for transparent dynamic reassembly of computing resource compositions, according to an embodiment. It may not be possible under some configurations or circumstances to find backup devices to substitute for a failing or failure-prone device. However, hardware virtualization enables creation of software virtual devices as backups. For example, a network device may be virtualized by a virtual NIC and a local storage device may be virtualized by a software emulator over a remote block pool.

In FIG. 12, the flow is similar in some respects to the process 1000 of FIG. 10. The CLUB manager may determine that failing device D cannot be replaced with a backup device (e.g., at operation 1205). The CLUB manager issues a freeze on a platform server and the platform server notifies the operating system to suspend software thread and to drain I/O queues (e.g., at operation 1210). The operating system notifies the CLUB manager that all application threads and OS daemons are in suspension (e.g., at operation 1215).

Failing device D needs to be reconfigured to operate in a more conservative mode and to get its updates redirected so that D may be taken offline or degraded once a virtual backup device E may be ready to take over the functions of D. The CLUB manager directs the microvisor to intercept and perfromperform accesses to D using conservative access methods (e.g., using more power, less bandwidth, etc., e.g., at operation 1220). The CLUB manager notifies the platform server and the operating system to release all threads from suspension (e.g., at operation 1225). D is operated in a slow or conservative or high power, low frequency mode. Once this is completed, the CLUB manager temporarily freezes application software, and then hot-unplugs D while hot-plugging E in D's place, and then unfreezes application software execution.

The CLUB manager spins up a virtual backup device E and initiates a replication of the contents of D to E. The E is a virtual device so it is not efficient nor practical to startup and keep both a primary backup device E and yet another virtual device that acts as a secondary backup device in sync. The overhead would defeat the purpose of using a non-virtual device for production use. So E is created or spun-up on demand—which should be a sufficiently rare occurrence that it makes the overhead of using virtualization as a means of preserving uptime an attractive value proposition. Therefore, E is created and D is replicated asynchronously to E during replication. In an example, synchronization of D to E may be synchronous or asynchronous. Asynchronous synchronization be less complex because D is operational and E is spinning up. Under some resiliency scenarios it may be necessary to do a synchronous spin up (e.g., when D is a real-time controller of a mission critical application, etc.). The CLUB manager directs the operating system to release all cacheable pages to freelist (e.g. drop-caches) and to remap D to E in the tables of the operating system (e.g., at operation 1240). The CLUB manager directs the microvisor to rename D to device F and F is placed in a mode that limits the operating system to only make F available to debug and trace utilities (e.g., at operation 1245). The CLUB manager directs the OS to resume normal operation when D has been either fully replaced by E (e.g., at operation 1250) or when E has been partially but sufficiently initialized that it can begin operating in place of D, while only delaying those actions that need data which has to be retrieved from D (now F) until such time that that data has been synchronized into E

Virtualized devices are used for the online substitution of physical devices by other physical devices and by virtual devices when a server runs out of physical backup devices. Making the transition without disturbing application software layers uses virtualization to enable a solution for graceful continuation of operations and for controlled, non-chaotic, migration of tasks from one group of devices to other groups of devices or from a server to other servers. The systems and techniques accomplish these features using an architecture comprising the CLUB manager, the microvisor, and a reconstitutable server. A reconstitutable server is a server in which components may be reassigned identities and accesses may be remapped according to those identities. Signals and protocols between the CLUB manager and server software (including VMM and OS) may be frozen and released. Extensions to the OS and the VMM software respond to freeze and release-from-freeze signals

Resiliency telemetry is directed from the server to the microvisor and a model at the microvisor reduces and thresholds the telemetry to detect when to escalate a failure to a CLUB manager. Architectural provisions in the design of server integrating elements apply different timings and frequencies of operation to a device being operated in a conservative mode. On-demand virtualized backup device creation is enabled for a device for which no physical backup device is available. A fully shared memory-based transport channel is converted into more than one partially shared memory-based transport channel and a loopback based (e.g., non-shared-memory) bridge is established between the more than one partially shared memory-based channels. A primary-backup and secondary-backup devices table is maintained that is populated by and used by the microvisor under the direction of the CLUB manager.

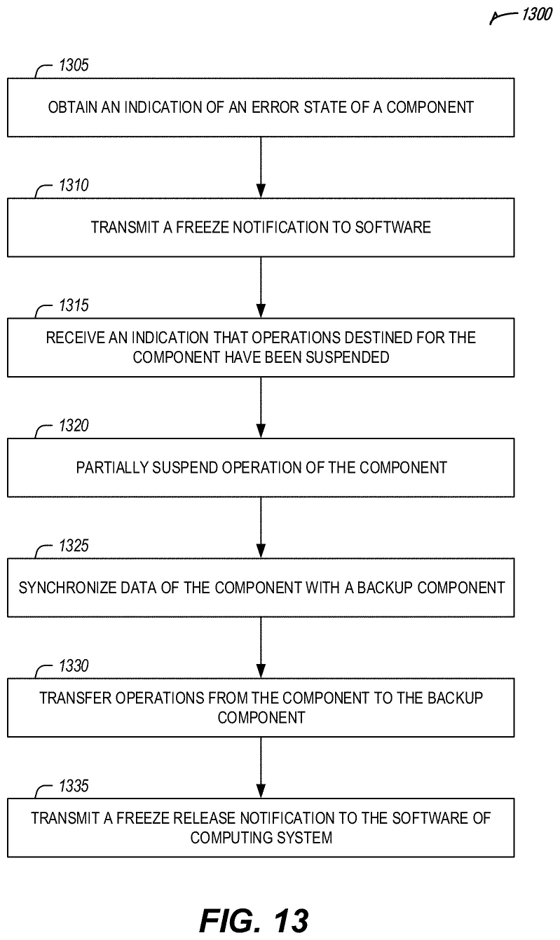

FIG. 13 is a flow chart of an example of a method 1300 for transparent dynamic reassembly of computing resource compositions, according to an embodiment. The method 1300 may provide features as described in FIGS. 8 to 12.

An indication may be obtained (e.g., by the CLUB manager 835 as described in FIG. 8, etc.) of an error state of a component of a computing system (e.g., at operation 1305). In an example, the error state may be a soft error indicating the component is operating at a degraded performance level. In another example, the error state may be a hard error indicating the component is no longer operating. In an example, the component may be a memory component, a processing component, a networking component, a storage component, or a pooled resource component.

An offload command (e.g., a freeze notification, etc.) may be transmitted to component management software (e.g., OS, VMM, etc.) of the computing system (e.g., at operation 1310). For example, a freeze notification may be transmitted to software of the computing system. In an example, the freeze notification may instruct the software of the computing system to suspend software threads and allow input/output queues to empty. In an example, the software of the computing system may be an operating system or a virtual machine manager.

An indication may be received (e.g., from an operating system, virtual machine manager, etc. of the server 805 as described in FIG. 8) indicating that operations/workloads destined for the component have been suspended (e.g., at operation 1315). Operation of the component may be partially suspended (e.g., at operation 1320). An administrative mode command may be transmitted to the component. The administrative mode command may place the component in partial shutdown to prevent the component from receiving non-administrative workloads.

Data of the component may be synchronized with a backup component (e.g., at operation 1325). In an example, the backup component may be a composition of resources that, when combined, provide a function of the component. In an example, synchronization of the data of the component with the backup component may be completed asynchronously. In another example, synchronization of the data of the component with the backup component is completed synchronously. In an example, a secondary backup component may be identified for the backup component. The secondary backup component may be assigned as a primary backup for the backup component. A new backup component may be identified and the new backup component may be assigned as the secondary backup component. In an example, the new primary backup device may be polled. In response to the poll, it may be determined that the primary backup device is unavailable to serve as the backup component and the secondary backup component may be promoted to a primary backup component. In an example, a polling interval may be determined for the poll based on a service level agreement for a computing environment that includes the component. In another example, the new primary backup device may be polled. In response to the poll, it may be determined that the primary backup device is unavailable to serve as the backup component. A search may be conducted for an alternate primary component and the alternate primary component may be assigned as the new primary backup device.

In an example, it may be determined that a physical component is not available as the backup component. A virtual backup component may be generated and the virtual backup component may be assigned as the backup component.

Operations/workloads may be transferred from the component to the backup component (e.g., at operation 1330). In an example, access modes for the component may be altered to complete replication of data from the component to the backup component. In another example, the component may be referred to by an alias and the alias may be reassigned from the component to the backup component, the component may be mapped to another alias, etc. It may be determined that replication has completed and the component may be taken offline or the component may be reassigned to a degraded state. In an example, access to the component may be remapped to the backup component. A offload/freeze release notification/command may be transmitted to the software/component management software of the computing system (e.g., at operation 1335) returning the software to normal operation using the backup component now operating as the primary component.

### ADDITIONAL NOTES & EXAMPLES

Example 1 is a network apparatus for transparent dynamic reassembly of computing resource compositions comprising: at least one processor; and memory including instructions that, when executed by the at least one processor, causes the at least one processor to perform operations to: obtain an indication of an error state of a component of a computing system; transmit an offload command to component management software of the computing system; receive an indication that workloads to be executed using the component have been suspended; transmit an administrative mode command to the component, wherein the administrative mode command places the component in partial shutdown to prevent the component from receiving non-administrative workloads; synchronize data of the component with a backup component; transfer workloads from the component to the backup component; and transmit an offload release command to the component management software of the computing system.

In Example 2, the subject matter of Example 1 includes subject matter wherein, the error state is a soft error to indicate that the component is operating at a degraded performance level.

In Example 3, the subject matter of Examples 1-2 includes subject matter wherein, the error state is a hard error to indicate that the component is no longer operating.

In Example 4, the subject matter of Examples 1-3 includes subject matter wherein, the offload command instructs the component management software of the computing system to suspend component management software threads and allow input/output queues to empty.

In Example 5, the subject matter of Examples 1-4 includes, the memory further comprising instructions that, when executed by the at least one processor, causes the at least one processor to perform operations to: identify a secondary backup component for the backup component; assign the secondary backup component as a new primary backup for the backup component; identify a new backup component; and assign the new backup component as the secondary backup component.

In Example 6, the subject matter of Example 5 includes, the memory further comprising instructions that, when executed by the at least one processor, causes the at least one processor to perform operations to: poll the new primary backup device; determine, in response to the poll, that the primary backup device is unavailable to serve as the backup component; and promote the secondary backup component to a primary backup component.

In Example 7, the subject matter of Examples 5-6 includes, the memory further comprising instructions that, when executed by the at least one processor, causes the at least one processor to perform operations to: poll the new primary backup device; determine, in response to the poll, that the primary backup device is unavailable to serve as the backup component; search for an alternate primary component assign the alternate primary component as the new primary backup device.

In Example 8, the subject matter of Examples 6-7 includes subject matter wherein, a polling interval for the poll is determined based on a service level agreement for a computing environment that includes the component.

In Example 9, the subject matter of Examples 1-8 includes, the memory further comprising instructions that, when executed by the at least one processor, causes the at least one processor to perform operations to: change access modes for the component to complete replication of data from the component to the backup component; determine that replication has completed; and logically remove the component from the computing system or reassign the component to a degraded state.

In Example 10, the subject matter of Examples 1-9 includes, the memory further comprising instructions that, when executed by the at least one processor, causes the at least one processor to perform operations to re-map access to the component from the backup component.

In Example 11, the subject matter of Examples 1-10 includes subject matter wherein, the component management software of the computing system is an operating system or a virtual machine manager.

In Example 12, the subject matter of Examples 1-11 includes, the memory further comprising instructions that, when executed by the at least one processor, causes the at least one processor to perform operations to: determine that a physical component is unavailable as the backup component; generate a virtual backup component; and assign the virtual backup component as the backup component.

In Example 13, the subject matter of Example 12 includes subject matter wherein, the component is a memory component, a processing component, a networking component, a storage component, or a pooled resource component.

In Example 14, the subject matter of Examples 1-13 includes subject matter wherein, the instructions to synchronize the data of the component with the backup component include instructions to complete synchronization using asynchronous communication.

In Example 15, the subject matter of Examples 1-14 includes subject matter wherein, the instructions to synchronize the data of the component with the backup component include instructions to complete synchronization using synchronous communication.

In Example 16, the subject matter of Examples 1-15 includes subject matter wherein, the backup component is a composition of resources that, when combined, provide a function of the component.

In Example 17, the subject matter of Examples 1-16 includes subject matter wherein, the component is referred to by an alias and, wherein the instructions to transfer the workloads from the component to the backup component include instructions to reassign the alias from the component to the backup component.

Example 18 is at least one non-transitory machine-readable medium including instructions for transparent dynamic reassembly of computing resource compositions that, when executed by at least one processor, causes the at least one processor to perform operations to: obtain an indication of an error state of a component of a computing system; transmit an offload command to component management software of the computing system; receive an indication that workloads to be executed using the component have been suspended; transmit an administrative mode command to the component, wherein the administrative mode command places the component in partial shutdown to prevent the component from receiving non-administrative workloads; synchronize data of the component with a backup component; transfer workloads from the component to the backup component; and transmit an offload release command to the component management software of the computing system.

In Example 19, the subject matter of Example 18 includes subject matter wherein, the error state is a soft error to indicate that the component is operating at a degraded performance level.

In Example 20, the subject matter of Examples 18-19 includes subject matter wherein, the error state is a hard error to indicate that the component is no longer operating.

In Example 21, the subject matter of Examples 18-20 includes subject matter wherein, the offload command instructs the component management software of the computing system to suspend component management software threads and allow input/output queues to empty.

In Example 22, the subject matter of Examples 18-21 includes, instructions that, when executed by the at least one processor, causes the at least one processor to perform operations to: identify a secondary backup component for the backup component; assign the secondary backup component as a new primary backup for the backup component; identify a new backup component; and assign the new backup component as the secondary backup component.

In Example 23, the subject matter of Example 22 includes, instructions that, when executed by the at least one processor, causes the at least one processor to perform operations to: poll the new primary backup device; determine, in response to the poll, that the primary backup device is unavailable to serve as the backup component; and promote the secondary backup component to a primary backup component.

In Example 24, the subject matter of Examples 22-23 includes, instructions that, when executed by the at least one processor, causes the at least one processor to perform operations to: poll the new primary backup device; determine, in response to the poll, that the primary backup device is unavailable to serve as the backup component; search for an alternate primary component assign the alternate primary component as the new primary backup device.

In Example 25, the subject matter of Examples 23-24 includes subject matter wherein, a polling interval for the poll is determined based on a service level agreement for a computing environment that includes the component.

In Example 26, the subject matter of Examples 18-25 includes, instructions that, when executed by the at least one processor, causes the at least one processor to perform operations to: change access modes for the component to complete replication of data from the component to the backup component; determine that replication has completed; and logically remove the component from the computing system or reassign the component to a degraded state.

In Example 27, the subject matter of Examples 18-26 includes, instructions that, when executed by the at least one processor, causes the at least one processor to perform operations to re-map access to the component from the backup component.

In Example 28, the subject matter of Examples 18-27 includes subject matter wherein, the component management software of the computing system is an operating system or a virtual machine manager.

In Example 29, the subject matter of Examples 18-28 includes, instructions that, when executed by the at least one processor, causes the at least one processor to perform operations to: determine that a physical component is unavailable as the backup component; generate a virtual backup component; and assign the virtual backup component as the backup component.

In Example 30, the subject matter of Example 29 includes subject matter wherein, the component is a memory component, a processing component, a networking component, a storage component, or a pooled resource component.

In Example 31, the subject matter of Examples 18-30 includes subject matter wherein, the instructions to synchronize the data of the component with the backup component include instructions to complete synchronization using asynchronous communication.

In Example 32, the subject matter of Examples 18-31 includes subject matter wherein, the instructions to synchronize the data of the component with the backup component include instructions to complete synchronization using synchronous communication.

In Example 33, the subject matter of Examples 18-32 includes subject matter wherein, the backup component is a composition of resources that, when combined, provide a function of the component.

In Example 34, the subject matter of Examples 18-33 includes subject matter wherein, the component is referred to by an alias and, wherein the instructions to transfer the workloads from the component to the backup component include instructions to reassign the alias from the component to the backup component.

Example 35 is a method for transparent dynamic reassembly of computing resource compositions comprising: obtaining an indication of an error state of a component of a computing system; transmitting an offload command to component management software of the computing system; receiving an indication that workloads to be executed using the component have been suspended; transmitting an administrative mode command to the component, wherein the administrative mode command places the component in partial shutdown to prevent the component from receiving non-administrative workloads; synchronizing data of the component with a backup component; transferring workloads from the component to the backup component; and transmitting an offload release command to the component management software of the computing system.

In Example 36, the subject matter of Example 35 includes subject matter wherein, the error state is a soft error indicating the component is operating at a degraded performance level.

In Example 37, the subject matter of Examples 35-36 includes subject matter wherein, the error state is a hard error indicating the component is no longer operating.

In Example 38, the subject matter of Examples 35-37 includes subject matter wherein, the offload command instructs the component management software of the computing system to suspend component management software threads and allow input/output queues to empty.

In Example 39, the subject matter of Examples 35-38 includes, identifying a secondary backup component for the backup component; assigning the secondary backup component as a new primary backup for the backup component; identifying a new backup component; and assigning the new backup component as the secondary backup component.

In Example 40, the subject matter of Example 39 includes, polling the new primary backup device; determining, in response to the poll, that the primary backup device is unavailable to serve as the backup component; and promoting the secondary backup component to a primary backup component.

In Example 41, the subject matter of Examples 39-40 includes, polling the new primary backup device; determining, in response to the poll, that the primary backup device is unavailable to serve as the backup component; searching for an alternate primary component assigning the alternate primary component as the new primary backup device.

In Example 42, the subject matter of Examples 40-41 includes subject matter wherein, a polling interval for the polling is determined based on a service level agreement for a computing environment that includes the component.

In Example 43, the subject matter of Examples 35-42 includes, changing access modes for the component to complete replication of data from the component to the backup component; determining that replication has completed; and logically removing the component from the computing system or reassign the component to a degraded state.

In Example 44, the subject matter of Examples 35-43 includes, re-mapping access to the component from the backup component.

In Example 45, the subject matter of Examples 35-44 includes subject matter wherein, the component management software of the computing system is an operating system or a virtual machine manager.

In Example 46, the subject matter of Examples 35-45 includes, determining that a physical component is unavailable as the backup component; generating a virtual backup component; and assigning the virtual backup component as the backup component.

In Example 47, the subject matter of Example 46 includes subject matter wherein, the component is a memory component, a processing component, a networking component, a storage component, or a pooled resource component.

In Example 48, the subject matter of Examples 35-47 includes subject matter wherein, the synchronizing the data of the component with the backup component is completed using asynchronous communication.

In Example 49, the subject matter of Examples 35-48 includes subject matter wherein, the synchronizing the data of the component with the backup component is completed using synchronous communication.

In Example 50, the subject matter of Examples 35-49 includes subject matter wherein, the backup component is a composition of resources that, when combined, provide a function of the component.

In Example 51, the subject matter of Examples 35-50 includes subject matter wherein, the component is referred to by an alias and, wherein transferring the workloads from the component to the backup component includes reassigning the alias from the component to the backup component.

Example 52 is at least one machine-readable medium including instructions that, when executed by a machine, cause the machine to perform any method of Examples 35-51.

Example 53 is a system comprising means to perform any method of Examples 35-51.

Example 54 is a system for transparent dynamic reassembly of computing resource compositions comprising: means for obtaining an indication of an error state of a component of a computing system; means for transmitting an offload command to component management software of the computing system; means for receiving an indication that workloads to be executed using the component have been suspended; means for transmitting an administrative mode command to the component, wherein the administrative mode command places the component in partial shutdown to prevent the component from receiving non-administrative workloads; means for synchronizing data of the component with a backup component; means for transferring workloads from the component to the backup component; and means for transmitting an offload release command to the component management software of the computing system.

In Example 55, the subject matter of Example 54 includes subject matter wherein, the error state is a soft error indicating the component is operating at a degraded performance level.

In Example 56, the subject matter of Examples 54-55 includes subject matter wherein, the error state is a hard error indicating the component is no longer operating.

In Example 57, the subject matter of Examples 54-56 includes subject matter wherein, the offload command instructs the component management software of the computing system to suspend component management software threads and allow input/output queues to empty.

In Example 58, the subject matter of Examples 54-57 includes, means for identifying a secondary backup component for the backup component; means for assigning the secondary backup component as a new primary backup for the backup component; means for identifying a new backup component; and means for assigning the new backup component as the secondary backup component.

In Example 59, the subject matter of Example 58 includes, means for polling the new primary backup device; means for determining, in response to the poll, that the primary backup device is unavailable to serve as the backup component; and means for promoting the secondary backup component to a primary backup component.

In Example 60, the subject matter of Examples 58-59 includes, means for polling the new primary backup device; means for determining, in response to the poll, that the primary backup device is unavailable to serve as the backup component; means for searching for an alternate primary component means for assigning the alternate primary component as the new primary backup device.

In Example 61, the subject matter of Examples 59-60 includes subject matter wherein, a polling interval for the polling is determined based on a service level agreement for a computing environment that includes the component.

In Example 62, the subject matter of Examples 54-61 includes, means for changing access modes for the component to complete replication of data from the component to the backup component; means for determining that replication has completed; and means for logically removing the component from the computing system or reassign the component to a degraded state.

In Example 63, the subject matter of Examples 54-62 includes, means for re-mapping access to the component from the backup component.

In Example 64, the subject matter of Examples 54-63 includes subject matter wherein, the component management software of the computing system is an operating system or a virtual machine manager.

In Example 65, the subject matter of Examples 54-64 includes, means for determining that a physical component is unavailable as the backup component; means for generating a virtual backup component; and means for assigning the virtual backup component as the backup component.

In Example 66, the subject matter of Example 65 includes subject matter wherein, the component is a memory component, a processing component, a networking component, a storage component, or a pooled resource component.

In Example 67, the subject matter of Examples 54-66 includes subject matter wherein, the means for synchronizing the data of the component with the backup component further comprises means for completing synchronization using asynchronous communication.

In Example 68, the subject matter of Examples 54-67 includes subject matter wherein, the means for synchronizing the data of the component further comprises means for completing synchronization using synchronous communication.

In Example 69, the subject matter of Examples 54-68 includes subject matter wherein, the backup component is a composition of resources that, when combined, provide a function of the component.

In Example 70, the subject matter of Examples 54-69 includes subject matter wherein, the component is referred to by an alias and, wherein the means for transferring the workloads from the component to the backup component includes means for reassigning the alias from the component to the backup component.

Example 71 is at least one machine-readable medium including instructions that, when executed by processing circuitry, cause the processing circuitry to perform operations to implement of any of Examples 1-70.

Example 72 is an apparatus comprising means to implement of any of Examples 1-70.

Example 73 is a system to implement of any of Examples 1-70.

Example 74 is a method to implement of any of Examples 1-70.

Example 75 is at least one machine-readable medium including instructions, which when executed by a machine, cause the machine to perform operations of any of the operations of Examples 1-70.

Example 76 is an apparatus comprising means for performing any of the operations of Examples 1-70.

Example 77 is a system to perform the operations of any of the Examples 1-70.

Example 78 is a method to perform the operations of any of the Examples 1-70.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A network apparatus for transparent dynamic reassembly of computing resource compositions comprising:
at least one processor; and
memory including instructions that, when executed by the at least one processor, causes the at least one processor to perform operations to:
obtain an indication of an error state of a component of a computing system;
transmit an offload command to component management software of the computing system;
receive an indication that workloads to be executed using the component have been suspended;
transmit an administrative mode command to the component, wherein the administrative mode command places the component in partial shutdown to prevent the component from receiving non-administrative workloads;
synchronize data of the component with a backup component;
transfer workloads from the component to the backup component; and
transmit an offload release command to the component management software of the computing system.

2. The network apparatus of claim 1, wherein the error state is a soft error to indicate that the component is operating at a degraded performance level.

3. The network apparatus of claim 1, wherein the error state is a hard error to indicate that the component is no longer operating.

4. The network apparatus of claim 1, wherein the offload command instructs the component management software of the computing system to suspend component management software threads and allow input/output queues to empty.

5. The network apparatus of claim 1, the memory further comprising instructions that, when executed by the at least one processor, causes the at least one processor to perform operations to:
identify a secondary backup component for the backup component;
assign the secondary backup component as a new primary backup for the backup component;
identify a new backup component; and
assign the new backup component as the secondary backup component.

6. The network apparatus of claim 5, the memory further comprising instructions that, when executed by the at least one processor, causes the at least one processor to perform operations to:
poll the new primary backup device;
determine, in response to the poll, that the primary backup device is unavailable to serve as the backup component; and
promote the secondary backup component to a primary backup component.

7. The network apparatus of claim 1, the memory further comprising instructions that, when executed by the at least one processor, causes the at least one processor to perform operations to:
change access modes for the component to complete replication of data from the component to the backup component;
determine that replication has completed; and
logically remove the component from the computing system or reassign the component to a degraded state.

8. The network apparatus of claim 1, the memory further comprising instructions that, when executed by the at least one processor, causes the at least one processor to perform operations to re-map access to the component from the backup component.

9. The network apparatus of claim 1, wherein the component management software of the computing system is an operating system or a virtual machine manager.

10. The network apparatus of claim 1, the memory further comprising instructions that, when executed by the at least one processor, causes the at least one processor to perform operations to:
determine that a physical component is unavailable as the backup component;
generate a virtual backup component; and
assign the virtual backup component as the backup component.

11. The network apparatus of claim 10, wherein the component is a memory component, a processing component, a networking component, a storage component, or a pooled resource component.

12. The network apparatus of claim 1, wherein the instructions to synchronize the data of the component with the backup component include instructions to complete synchronization using asynchronous communication.

13. The network apparatus of claim 1, wherein the instructions to synchronize the data of the component with the backup component include instructions to complete synchronization using synchronous communication.

14. The network apparatus of claim 1, wherein the backup component is a composition of resources that, when combined, provide a function of the component.

15. The network apparatus of claim 1, wherein the component is referred to by an alias and, wherein the instructions to transfer the workloads from the component to the backup component include instructions to reassign the alias from the component to the backup component.

16. At least one non-transitory machine-readable medium including instructions for transparent dynamic reassembly of computing resource compositions that, when executed by at least one processor, causes the at least one processor to perform operations to:
obtain an indication of an error state of a component of a computing system;
transmit an offload command to component management software of the computing system;
receive an indication that workloads to be executed using the component have been suspended;
transmit an administrative mode command to the component, wherein the administrative mode command places the component in partial shutdown to prevent the component from receiving non-administrative workloads;
synchronize data of the component with a backup component;
transfer workloads from the component to the backup component; and
transmit an offload release command to the component management software of the computing system.

17. The at least one non-transitory machine-readable medium of claim 16, further comprising instructions that, when executed by the at least one processor, causes the at least one processor to perform operations to:
identify a secondary backup component for the backup component;
assign the secondary backup component as a new primary backup for the backup component;
identify a new backup component; and
assign the new backup component as the secondary backup component.

18. The at least one non-transitory machine-readable medium of claim 16, further comprising instructions that, when executed by the at least one processor, causes the at least one processor to perform operations to:
change access modes for the component to complete replication of data from the component to the backup component;
determine that replication has completed; and
logically remove the component from the computing system or reassign the component to a degraded state.

19. The at least one non-transitory machine-readable medium of claim 16, further comprising instructions that, when executed by the at least one processor, causes the at least one processor to perform operations to:
determine that a physical component is unavailable as the backup component;
generate a virtual backup component; and
assign the virtual backup component as the backup component.

20. The at least one non-transitory machine-readable medium of claim 19, wherein the component is a memory component, a processing component, a networking component, a storage component, or a pooled resource component.

21. A method for transparent dynamic reassembly of computing resource compositions comprising:
obtaining an indication of an error state of a component of a computing system;
transmitting an offload command to component management software of the computing system;
receiving an indication that workloads to be executed using the component have been suspended;
transmitting an administrative mode command to the component, wherein the administrative mode command places the component in partial shutdown to prevent the component from receiving non-administrative workloads;
synchronizing data of the component with a backup component;
transferring workloads from the component to the backup component; and
transmitting an offload release command to the component management software of the computing system.

22. The method of claim 21, further comprising:
identifying a secondary backup component for the backup component;
assigning the secondary backup component as a new primary backup for the backup component;
identifying a new backup component; and
assigning the new backup component as the secondary backup component.

23. The method of claim 21, further comprising:
changing access modes for the component to complete replication of data from the component to the backup component;
determining that replication has completed; and
logically removing the component from the computing system or reassign the component to a degraded state.

24. The method of claim 21, further comprising:
determining that a physical component is unavailable as the backup component;
generating a virtual backup component; and
assigning the virtual backup component as the backup component.

25. The method of claim 24, wherein the component is a memory component, a processing component, a networking component, a storage component, or a pooled resource component.
